(19) United States
(12) Patent Application Publication
(10) Pub. No.: US 2023/0143420 A1
(43) Pub. Date: May 11, 2023

(54) DISTRIBUTION MODELING FOR ELECTRONIC SPORTS BETTING

(71) Applicant: EBET, Inc., Las Vegas, NV (US)

(72) Inventor: Jason Finch, Jackson, MS (US)

(21) Appl. No.: 17/983,322

(22) Filed: Nov. 8, 2022

Related U.S. Application Data
(60) Provisional application No. 63/276,840, filed on Nov. 8, 2021.

(51) Int. Cl. G07F 17/32

(52) U.S. Cl. CPC G07F 17/3288; G07F 17/323

(57) ABSTRACT

A method of modeling a multiplayer online battle arena (MOBA) video game, and a system for executing the same. The method includes compounding a Conway-Maxwell-Poisson (CMP) binomial distribution with one or more non-CMP distributions to generate a bivariate CMP distribution. The method further includes applying the bivariate CMP distribution to discrete events that can occur within the MOBA video game, the discrete events occurring within multiple rounds of the MOBA video game, each successive round of the MOBA video game having one or more dependencies on all previous rounds. The method further includes modeling the MOBA video game with the bivariate CMP distribution to generate pricing of any combination of discrete events in the MOBA video game, and receiving and storing bets from viewers on any combination of discrete events of the MOBA video game based on the pricing according to the bivariate CMP distribution.

### CROSS-REFERENCES TO RELATED APPLICATIONS

The present application claims priority of U.S. Provisional Application No. 63/276,840, filed Nov. 8, 2021, and entitled “DISTRIBUTION MODELING FOR ELECTRONIC SPORTS BETTING”, the entirety of which is incorporated by reference herein.

### TECHNICAL FIELD

The subject matter described herein relates to an electronic sports betting system and method, and more particularly to distribution modeling for electronic sports events for electronic sports betting.

### BACKGROUND

In electronic sports (“esports”) is a form of competition using video-based games, such as virtualized representations of physical games, or of battle games that pit one player or team against another. While esports can feature teams of one player, many modern esports games are multiplayer games, i.e., 2 or more players on a team. Further, there can be more than 2 teams in any competitive esports game or event.

Esports have become a very popular form of competition on which players and viewers can place bets. These bets can be placed on any of an unlimited number of dimensions of a game in progress, from a simple “kill” or death of one team or player by another, to a progress of a team or player at certain points of time within the game, and to any other measurable event or occurrence.

More frequently, esports betting platforms provide their users, or bettors, with probability models of anticipated outcomes. Modeling teams of one player is simple, since only one death is expected, for example, in the case of a first-person shooter (FPS) or other type of fighting game. But for teams or 2-n players, any number of players could die as a result of a fight within a game, and most conventional esports modeling is inadequate to properly model probabilistic behaviors and outcomes. Better modeling of the outcomes of games or aspects thereof is therefore becoming critically important to users.

A CM-Hermite distribution is absent from existing literature on CM distributions, as is a bivariate CM-Hermite and certainly a CM-Generalized Hermite. Accordingly, what is needed is an improved modeling technique for esports games, and therefore models based on more accurate probability distributions.

### SUMMARY

This document presents a modeling system and method for esports games or events that compounds a beta with a modified Conway-Maxwell-Poisson binomial distribution.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

In some aspects, a method of modeling a multiplayer online battle arena (MOBA) video game, and a system for executing the same. The method includes compounding a Conway-Maxwell-Poisson (CMP) binomial distribution with one or more non-CMP distributions to generate a bivariate CMP distribution. The method further includes applying the bivariate CMP distribution to discrete events that can occur within the MOBA video game, the discrete events occurring within multiple rounds of the MOBA video game, each successive round of the MOBA video game having one or more dependencies on all previous rounds. The method further includes modeling the MOBA video game with the bivariate CMP distribution to generate pricing of any combination of discrete events in the MOBA video game, and receiving and storing bets from viewers on any combination of discrete events of the MOBA video game based on the pricing according to the bivariate CMP distribution.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an esports betting system and method, it should be readily understood that such features are not intended to be limiting.

### BRIEF DESCRIPTION OF THE DRAWING

FIG. 1 is a flowchart of a method 100 of modeling a multiplayer online battle arena (MOBA) video game, in accordance with methods and techniques described herein.

### DETAILED DESCRIPTION

This document presents a modeling system and method for esports games or events that compounds a beta with a modified Conway-Maxwell-Poisson (CMP) binomial distribution.

The CMP distribution is a discrete probability distribution that generalizes a Poisson distribution by adding a parameter to model over dispersion and under-dispersion. The CMP distribution has existed since 1962 but was generally overlooked until a revival by Kadane and Shmueli in 2005. Since then, variations of the distribution have been studied and applied in biology and actuarial sciences. In implementations consistent with the currently described subject matter, this family of distributions is improved and tailored for esports by compounding it with other distributions (beta), applying the dispersion parameter to other distributions (Hermite), and providing methods of fitting data.

The main results of this as applied to esports are described below. In some implementations of an esports betting platform, modeling a multiplayer online battle arena (MOBAs) of a FPS video game, which allows for pricing any combination of kills by two teams via a bivariate CMP distribution. This is novel as it allows the exact score distribution of kills in multiplayer online battle arenas (MOBAs) of a FPS video game to be represented, including strikes far in the tails of the binomial distribution. Additionally, a combination or mixture distribution of two bivariate CMP distributions is generated to further enhance the probability distribution and improve the models.

The use of a bivariate CMP Hermite style distribution allows for increased accuracy (e.g., kills can come in groups as opposed to 0-1,1-0,1-1). This also has applications to battle royale modeling. The CM-Hermite-2 case can be used to closed form (modulo the CM constant) and convert it to bivariate (arrivals come in groups of 1 or 2). CM-Hermite-3 or greater variables can be generated to fully represent team fights or squad fights (4 or 5 players) and can include numeric speedups for live prices. Each CM-Hermite-n case can be rapidly evaluated via Monte Carlo integration.

A method, and a system using such method, for fitting censored CM-binomial data is also presented. An example of this is CSGO where teams play up to 30 rounds but stop when a team reaches 16 rounds. A final score of 16-10 is essentially censored data as the full number of Bernoulli trials are not performed. Given the correlated nature of CSGO rounds, a CM approach is typically needed to capture round dependencies. However, the effect of the CM dispersion parameter is a function of N. The methods described herein allows for a single CM-dispersion parameter to be fit and for the evaluation of early-stopping distributions. The CM-dispersion parameter can also be applied to a multinomial distribution.

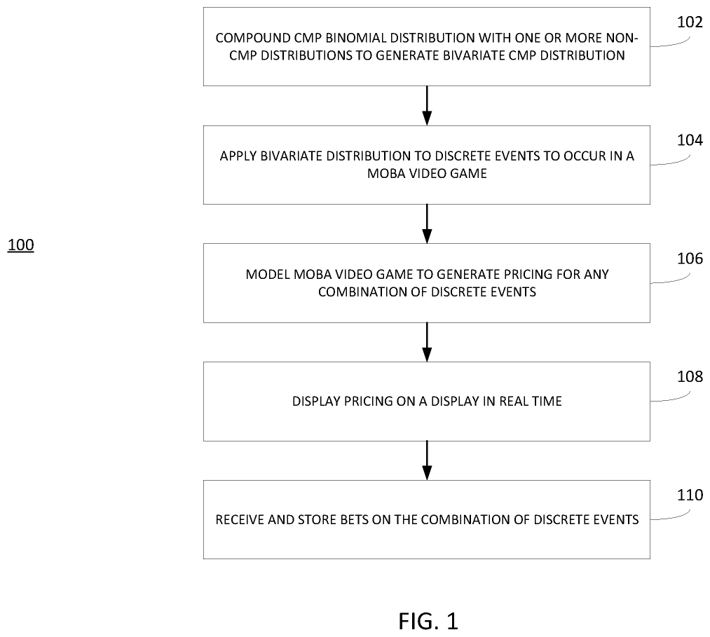

FIG. 1 is a flowchart of a method 100 of modeling a multiplayer online battle arena (MOBA) video game. At 102, a Conway-Maxwell-Poisson (CMP) binomial distribution is compounded with one or more non-CMP distributions to generate a bivariate CMP distribution. At 104, the bivariate CMP distribution is applied to discrete events that can occur within the MOBA video game. The discrete events occur within multiple rounds of the MOBA video game, where each successive round of the MOBA video game has one or more dependencies on all previous rounds. In preferred implementations, each of the discrete events is a kill of one character in the MOBA video game by another character, each character being controlled by a player of the MOBA video game.

At 106, execution or play of the MOBA video game is modeled with the bivariate CMP distribution to generate pricing of any combination of discrete events in the MOBA video game. At 108, a representation of the pricing is generated in real time as the MOBA video game is played. The representation can be displayed on an electric display associated with a computer that displays the MOBA video game. At 110, bets are received and stored from viewers on any combination of discrete events of the MOBA video game based on the pricing according to the bivariate CMP distribution.

In some implementations, the method 100 can further include combining the bivariate CMP distribution with a second bivariate CMP distribution that has been generated by compounding with at least one other non-CMP distribution.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. Method of modeling a multiplayer online battle arena (MOBA) video game, the method comprising:
compounding a Conway-Maxwell-Poisson (CMP) binomial distribution with one or more non-CMP distributions to generate a bivariate CMP distribution;
applying the bivariate CMP distribution to discrete events that can occur within the MOBA video game, the discrete events occurring within multiple rounds of the MOBA video game, each successive round of the MOBA video game having one or more dependencies on all previous rounds;
modeling the MOBA video game with the bivariate CMP distribution to generate pricing of any combination of discrete events in the MOBA video game; and
receiving and storing bets from viewers on any combination of discrete events of the MOBA video game based on the pricing according to the bivariate CMP distribution.

2. The method in accordance with claim 1, further comprising combining the bivariate CMP distribution with a second bivariate CMP distribution that has been generated by compounding with at least one other non-CMP distribution.

3. The method in accordance with claim 1, wherein each of the discrete events is a kill of one character in the MOBA video game by another character, each character being controlled by a player of the MOBA video game.

4. The method in accordance with claim 1, further comprising generating, on a display, a representation of the pricing in real time as the MOBA video game is played.

5. A computer program product comprising a non-transitory machine-readable medium storing instructions that, when executed by at least one programmable processor, cause the at least one programmable processor to perform operations comprising:
compound a Conway-Maxwell-Poisson (CMP) binomial distribution with one or more non-CMP distributions to generate a bivariate CMP distribution;
apply the bivariate CMP distribution to discrete events that can occur within the MOBA video game, the discrete events occurring within multiple rounds of the MOBA video game, each successive round of the MOBA video game having one or more dependencies on all previous rounds;
model the MOBA video game with the bivariate CMP distribution to generate pricing of any combination of discrete events in the MOBA video game; and
receive and store bets from viewers on any combination of discrete events of the MOBA video game based on the pricing according to the bivariate CMP distribution.

6. The computer program product in accordance with claim 5, wherein the operations further comprise an operation to combine the bivariate CMP distribution with a second bivariate CMP distribution that has been generated by compounding with at least one other non-CMP distribution.

7. The computer program product in accordance with claim 5, wherein each of the discrete events is a kill of one character in the MOBA video game by another character, each character being controlled by a player of the MOBA video game.

8. The computer program product in accordance with claim 5, wherein the operations further comprise an operation to generate, on a display, a representation of the pricing in real time as the MOBA video game is played.

9. A system comprising:
a programmable processor; and
a non-transitory machine-readable medium storing instructions that, when executed by the processor, cause the at least one programmable processor to perform operations comprising:
compound a Conway-Maxwell-Poisson (CMP) binomial distribution with one or more non-CMP distributions to generate a bivariate CMP distribution;
apply the bivariate CMP distribution to discrete events that can occur within the MOBA video game, the discrete events occurring within multiple rounds of the MOBA video game, each successive round of the MOBA video game having one or more dependencies on all previous rounds;
model the MOBA video game with the bivariate CMP distribution to generate pricing of any combination of discrete events in the MOBA video game;
receive and store bets from viewers on any combination of discrete events of the MOBA video game based on the pricing according to the bivariate CMP distribution; and
generate, on a display, a representation of the pricing in real time as the MOBA video game is played.

10. The system in accordance with claim 9, wherein the operations further comprise an operation to combine the bivariate CMP distribution with a second bivariate CMP distribution that has been generated by compounding with at least one other non-CMP distribution.

11. The system in accordance with claim 9, wherein each of the discrete events is a kill of one character in the MOBA video game by another character, each character being controlled by a player of the MOBA video game.
